(19) United States
(12) Patent Application Publication
(10) Pub. No.: US 2003/0072336 A1
(43) Pub. Date: Apr. 17, 2003

(54) Miniaturized internal laser stabilizing apparatus with inline output for fiber optic applications

(75) Inventors: Udayan Senapati, Chico, CA (US); Brant Wilhelm, Redding, CA (US)

Correspondence Address: HELLER EHRMAN WHITE & MCAULIFFE LLP, 275 MIDDLEFIELD ROAD, MENLO PARK, CA, 94025-3506, US

(73) Assignee: Spectra-Physics Lasers, Inc., Mountain View, CA (US)

(21) Appl. No.: 10/242,324

(22) Filed: Sep. 11, 2002

Related U.S. Application Data
(60) Provisional application No. 60/322,175, filed on Sep. 13, 2001.

(51) Int. Cl. H01S 3/13; H01S 3/00

(52) U.S. Cl. 372/32; 372/29.02; 372/38.01

(57) ABSTRACT

A laser system is provided comprising of a laser source including a laser stabilizing control loop and a laser housing, the laser source producing an output beam. The laser system includes a wavelength selective optical member positioned in the laser housing, the wavelength selective optical member adjusting wavelength and output power of the output beam in response to wavelength or power fluctuations of the laser source due to intrinsic aging of the laser source or due to extrinsic local environmental changes. In some embodiments, the laser system is miniaturized and the wavelength selective optical members supports a zero beam path offset configuration.

The present application claims the benefit of priority from commonly assigned, co-pending U.S. Patent Application Ser. No. 60/322,175, (Attorney Docket No. 39315-0740) filed Sep. 13, 2001. The complete disclosure of all applications listed above are incorporated herein by reference for all purposes.

### BACKGROUND OF THE INVENTION

1. Field of the Invention

The present invention relates generally to laser systems and more specifically to wavelength and intensity control of energy output from laser systems.

2. Description of Related Art

Spectral and intensity characteristics of semiconductor lasers are of prime importance in fiber optic telecommunication systems, as stable intensity and single-mode operation is required to optimize the bit error rate (BER) in telecommunication systems. The lasers of these systems are typically tuned for single-mode operation, producing light at a predetermined wavelength, λ₀. In reality, some portion of light produced by the laser does not have wavelength λ₀. However, the distribution of wavelengths produced should be centered around λ₀ and not spread over a large range of wavelengths. As the lasers are used, however, the resonant characteristics of the laser cavity may change, thus altering the output of the laser. Consequently, the wavelength of the light produced by the laser may drift from the desire predetermined wavelength output. In other words, the distribution of wavelengths produced may not be centered around the desired λ₀. In optical communication systems, the drift of laser output away from a desired output wavelength can result in undesired crosstalk between nearby communication channels or cause other performance degradations.

The success of fiber optics based telecommunications is to some extent dependent on the stability of these source lasers. Emission wavelength and intensity of these single mode lasers typically depends on many factors such as temperature, bias current, modulation and aging. Furthermore, with the advent of tunable lasers for such applications and due to wide tuning range of such lasers, there is an inherent wavelength and intensity drift. Hence, there is a desire to use wavelength lockers to stabilize the wavelength and intensity of such lasers.

Many forms of wavelength lockers have been developed for stabilizing both the spectral/frequency and intensity characteristics of solid state lasers used in fiber-optic telecommunications systems. Most of these devices use a frequency dependent optical component for providing the frequency portion of the error signal output and a direct coupling to a photodetector to provide the intensity portion of the output. These devices have been developed using many different concepts and configurations to maintain laser output centered about a desired λ₀.

Other methods of achieving stability and single mode operation involve using more expensive devices such as Distributed Feed Back (DFB) lasers, based on a grating structure in the active region, Distributed Bragg Reflectors (DBR) lasers, based on a grating structure in the passive region and Cleaved Coupled-Cavity (C3) lasers. In the latter, the laser is stabilized by a directly coupled resonant cavity.

These laser solutions, while both new and expensive, still do not perform adequately in controlling the operation of a laser in stable, single mode applications. Specifically, these applications require that the output bandwidth of a 100 GHz source does not oscillate more than 50 GHz or 0.4 nm. The reason for this being that the frequency of the gratings used in stabilizing these lasers change over time and, hence, need to have their own reference frequency standards. To date integrated gratings, which have the ability to precisely reflect and maintain a frequency within 50 GHz of the International Telecommunications Union (ITU) GRID, have been very difficult to fabricate and, so far, the yield rates are poor.

### SUMMARY OF THE INVENTION

The present invention provides an improved wavelength locker for use in a laser system. Specifically, the present invention provides improved methods, systems, and devices for providing cost effective wavelength locking and devices sized for internal integration into tunable laser sources.

In one aspect of the present invention, a laser system is provided comprising of a laser source including a laser stabilizing control loop and a laser housing, the laser source producing an output beam. The laser system includes a wavelength selective optical member positioned in the laser housing, the wavelength selective optical member adjusting wavelength and output power of the output beam in response to wavelength or power fluctuations of the laser source due to intrinsic aging of the laser source or due to extrinsic local environmental changes. In some embodiments, the laser system is miniaturized and the wavelength selective optical members supports a zero beam path offset configuration.

In another aspect of the present invention, a wavelength locker is provided for controlling the wavelength and measuring the optical power of an output beam from a laser source. The wavelength locker comprises of a first beam splitter positioned in a beam path and receiving light produced by the laser source, the first beam splitter splitting a first beam into a second beam and a third beam. The wavelength locker may include a wavelength selective optical member positioned to receive the second beam from the first beam splitter and generate a fourth beam with an optical power that varies periodically with wavelength. A first detector may be included that generates a first signal in proportion to an optical power of the fourth beam. The wavelength locker may also include means for generating a second signal from which the optical power of the output beam can be derived; and wherein a wavelength of the output beam is adjusted in response to a comparison of the first and second signals and a predetermined reference signal level.

In one embodiment, the present invention may provide a wavelength locker that combines features offering a number of advantages in modem fiber-optic communication systems. It should be understood that not all embodiments of the present invention need provide these advantages. The first is that the present invention may have an in-line or zero beam offset configuration so that the input and output beams may be more easily directly coupled into fibers. The second is that it may be miniaturized so that it will fit directly into a standard semiconductor laser housing and thus be able to take advantage of the thermoelectric temperature control inside the laser package and, in fact may be designed such that it includes the temperature control system. Third, as it may be etalon based, the present invention may be compatible with all channels provided by the tunable laser source. These features provide a unique approach to the problem of source laser stabilization in fiber optic telecommunications.

In another embodiment, the present invention may provide a wavelength locker that is mounted and pre-aligned on a single platform designed to hold those desired components between the diode laser and the output coupling fiber pigtail. These components may include, but are not limited to, the wavelength sensitive element, two beam splitters, a thermistor, a thermoelectric cooler/heater and two photodiodes. The wavelength locker may provide for supplying output of the second beam splitter directly to a gradient index lens (GRIN) mounted to the same platform. Such a GRIN lens could thus avoid the second integration alignment between the output focusing lens and the output fiber pigtail. The present invention may further provide a wavelength locker whose inline or zero beam path deviation optical configuration allows it to be incorporated into a standard 14-pin butterfly packaged tunable semiconductor laser as it provides for minimal alignment during integration.

In another aspect of the present invention, a method is provided for controlling wavelength and optical power. The method comprises providing a housing containing a laser and a wavelength locker and sending a laser output from the laser to the wavelength locker; directing said laser output through a first beam splitter in the housing, wherein said laser output entering the first beam splitter along a first longitudinal axis and exiting the first beam splitter along a second longitudinal axis. The laser output may be directed through a second beam splitter in the housing, wherein said laser output exiting said second beam splitter is aligned to the first longitudinal axis and directing said laser output out of the housing. The method may further include using an etalon to determine wavelength error in the laser output, wherein output from the etalon is adjusted for by a measurement from a thermal sensor to account for shifts in temperature. Additionally, a reference filter may be coupled to one of the beam splitters to determine if light from the laser source is at a desired wavelength or used to provide a reference wavelength. The first beam splitter may be configured to send light through the reference filter to an optical sensor and first beam splitter sends light directly to the optical sensor without passing through the reference filter. The method may use an error signal having different polarity for increasing and decreasing wavelengths or wavelength error.

A further understanding of the nature and advantages of the invention will become apparent by reference to the remaining portions of the specification and drawings.

### BRIEF DESCRIPTION OF THE FIGURES

FIG. 1 is a schematic showing a laser system for use with the present invention.

FIG. 2 shows laser housing having a wavelength locker according to the present invention.

FIG. 3 provides a detailed view of a wavelength locker according to the present invention.

FIG. 4 shows one configuration for the beam splitters according to the present invention.

FIG. 5 illustrates wavelengths in an etalon.

FIG. 6 provides a detailed view of another wavelength locker according to the present invention.

### DETAILED DESCRIPTION

The present invention relates to improvements in wavelength lockers. In one embodiment, the present invention provides a miniaturized, fiber-coupled apparatus for stabilizing both the wavelength and output power of lasers and more specifically, semiconductor lasers. The present invention may provide an internal sensor that sends input information to a control system, which stabilizes the output wavelength and intensity of a tunable source laser. The laser may be a diode laser, an edge-emitting Fabry-Perot Laser, a VCSEL (Vertical Cavity Surface Emitting Laser) or any laser whose output is ultimately coupled to an optical fiber in a fiber-optic communications system and acting as a transmitter or eventually, an amplifier.

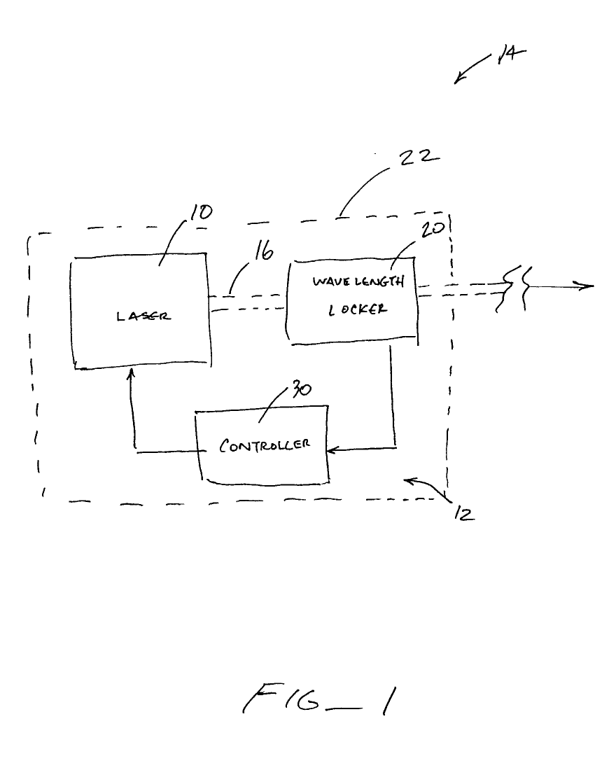

Referring now to FIG. 1, one embodiment of the present invention will now be described in detail. As seen in the figure, stable single-mode operation of a laser source 10 can be achieved by incorporating an intensity and wavelength control loop 12 around a laser system 14. An output beam 16 from laser source 10 is directed into a wavelength locker 20, according to the present invention, prior to exiting the laser housing 22. In the laser stabilizing control loop 12, the wavelength and intensity sensitive detecting device or wavelength locker 20 creates an error signal, which, in turn, is used as the input signal to the laser stabilizing control loop. This wavelength locker 20 may be based on a wavelength sensitive optical component or member such as an etalon, narrow-bandpass thin-film filter, fiber Bragg grating, volume hologram or Lyot Filter.

The wavelength selective optical member 20 may be used to adjust the wavelength and output power of the output beam 16 in response to wavelength or power fluctuations of the laser source 10 due to intrinsic aging of the laser source or due to extrinsic local environmental changes. A controller 30 such as a microprocessor or similar logic device may be used as part of the control loop 12 to adjust the output beam 16 of laser source 10 if the wavelength locker 20 detects undesired changes in the characteristics of the output beam. In this particular embodiment, while the controller 30 is shown to be contained within the laser housing 22, it should be understood that the controller may also be located outside the housing, such as at a central controller for the entire laser system. It should also be understood that the laser source 10 may be a tunable laser such as a VCSEL based tunable laser or like to provide laser output over a variety of wavelengths.

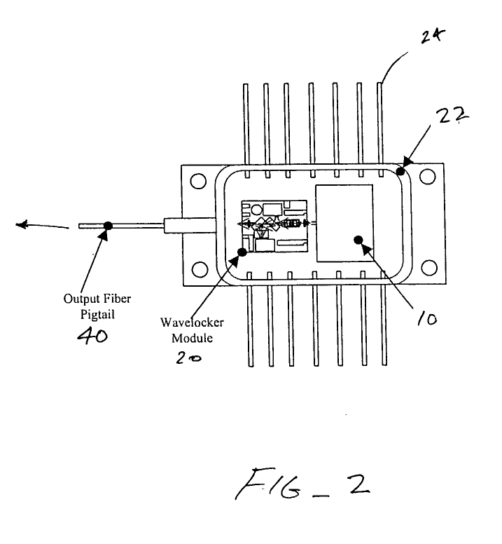

Referring now to FIG. 2, a specific embodiment of the present invention will now be described. The fiber optics telecom industry is currently using a standard 14-pin butterfly laser housing 22 to package a laser source 10 such as a laser chip along with some isolation, collimation and focusing optics. The dimensions of the butterfly package may be between about 9-11×,12-14,×29-31 mm³ or typically 10×13×30 mm³. The proposed internal wavelength locker 20 of the present invention may be a module mounted in front of the semiconductor laser chip in a front facet laser source 10. The housing 22 includes a plurality of pins 24 which may be used to carry signals to a controller 30 (not shown) located outside the housing for controlling the output beam of laser source 10. The pins 24 may also be used to supply power and provide other communications with the system using the laser source 10.

One advantage of the wavelength locker 20 in the present invention is that it is may have a zero beam offset configuration. This allows for the laser source 10 and the wavelength locker 20 to be easily aligned and integrated into the standard housing. As shown in FIG. 2, the output beam 16 from the laser source 10 traverses through the internal wavelength locker 20 and may then be focused on a fiber pigtail 40. A zero beam offset configuration for the internal wavelength locker 20 helps to facilitate the alignment of the laser source 10, the internal wavelength locker 20, and the fiber pigtail 40, all in one plane. This would imply that a minimal amount of active alignment would be required to optimize the power output from the laser source. This is particularly helpful since the industry dynamics in fiber optics telecommunications are such that there is a trend towards driving the product costs down. One of the factors contributing to the high product costs of the source modules is the necessary active alignment for optical components to optimize the output optical power from such modules. Hence, the wavelength locker 20 may be designed to incorporate a plurality of devices on one platform. The advantage of such a configuration is that it eliminates redundant alignments inside a butterfly package during assembly. Due to space constraints inside such a package the equipment needed to do active alignments in six degrees of freedom is be highly sophisticated. Even with this, one risks damaging the laser chip if there is excessive handling.

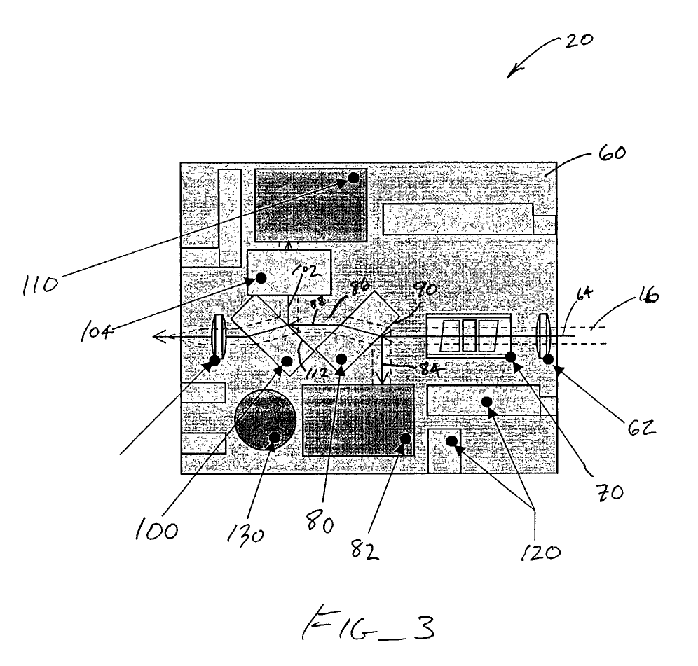

Referring now to FIG. 3, one embodiment of the wavelength locker 20 will be described in detail. As shown in FIG. 3, all elements of the wavelength locker 20 may be mounted on a platform 60. Light such as the output beam 16 from the laser source 10 enters the wavelength locker 20 through a lens 62. The lens 62 may be a collimating lens for collimating the output beam 16 emitted from the laser source 10. The output beam 16 enters the wavelength locker 20 along a first longitudinal axis indicated by arrow 64. The beam 16 may then pass through an isolator core 70 for eliminating feedback noise into the laser source 10. If included, the isolator core 70 may be positioned in a variety of locations along the beam path through the platform, so long as it is positioned in a location sufficient for preventing feedback to the laser source 10. The output beam 16 may then encounter the first beam splitter 80. As shown in the embodiment of FIG. 2, the first beam splitter 80 is used in conjunction with an optoelectronic device 82 such as a photodiode or photosensor for monitoring the laser intensity, which would be a wavelength independent response. The device 82 would generate a signal corresponding to the intensity of light received.

In this embodiment, the beam splitter 80 may split output beam 16 into a first beam 84 and a second beam 86. The first beam 84 would be directed at optoelectronic device 82 while the second beam 86 would continue onwards along a second longitudinal axis as indicated by arrow 88. The first beam splitter 80 may be such that it taps off only a few percent of the light. For example, the beam splitter 80 may be a BK7 glass with AR coating on one side creating a partially reflective surface 90 that directed a few percentage of light on beam 84 to the optoelectronic device 82. For illustration, this glass may reflect about 4% of the light at 1550 nm or at some other desired wavelength towards device 82.

As light passes through the first beam splitter 80, it may be shifted along a new axis as seen in FIG. 3. The beam 86 leaving the beam splitter 80 may be traveling along a second longitudinal axis 88. This beam 86 may then enter a second beam splitter 100 which directs a portion of beam 86 to a third beam 102 towards a wavelength selective optical member 104. Light passing through the wavelength selective optical member 104 would form another beam and be directed to an optoelectronic device 110 such as a photodiode or photosensor. The response of the second optoelectronic device 110 will be a wavelength dependent response. If wavelength of light is drifting away from the desired wavelength, the amount of light reaching the optoelectronic device 110 would diminish and the signal from the device would indicate such a drift. Monitoring of the wavelength may be done on a positive or a negative slope on the etalon response. The control algorithm may be tailored to have a zero error signal, i.e., the difference between the reference and the etalon signal is zero at the desired operating wavelength or frequency. If the positive slope is chosen, when the wavelength of the laser drifts towards higher wavelength one gets a positive error signal (assuming error signal=PD(etalon)−PD(reference)) and likewise if the wavelength drifts towards lower wavelength than the desired value one gets a negative error signal.

As previously mentioned, the wavelength locker 20 according to the present invention may be mounted on a platform 60 such as a single board made of Al₂O₃ that has had the electronic interfacing bond pads 120 lithographed onto its upper surface. The platform 60 may also include a focusing lens 122 for coupling to the output fiber pigtail 40. The lens 122 may be a gradient index lens (GRIN) mounted to the same platform. Such a GRIN lens could thus avoid the second integration alignment between the output focusing lens and the output fiber pigtail. The platform may also include a thermistor 130 for use in temperature control of the wavelength locker.

The second beam splitter 104 may be positioned in a manner sufficient to align the beam exiting it to be aligned with the first longitudinal axis 64. Using Snell's law (n1sin □1=n2sin ═2) one can show that the incident collimated beam through the first beam splitter 80 has zero beam deviation or offset on its exit through the second beam splitter 110. This lends itself to ease of alignment in a packaged laser source 10 and overall package integration. In one embodiment, the second beam splitter 110 may be mounted at about 90 degrees or orthogonal to the first beam splitter 82. The second beam splitter 110 may also be made out of BK7 glass with an AR coating creating a partially reflective surface 112, tapping off another 4% of the light.

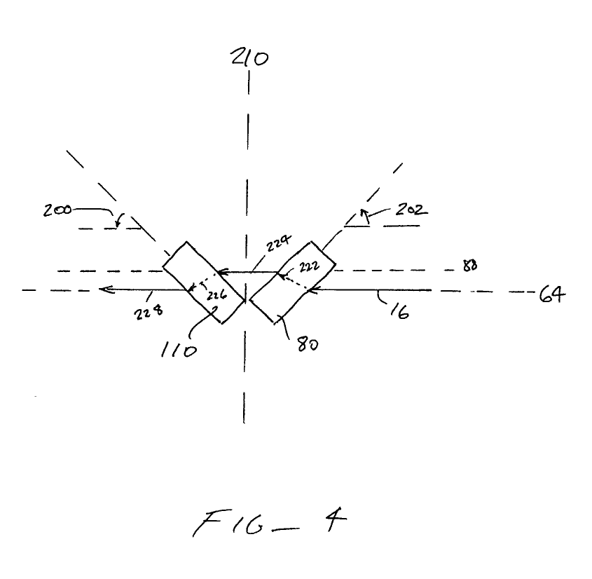

Referring now to FIG. 4, the zero beam offset configuration of the beam splitters 80 and 110 will be described further. The beam splitters may be positioned at slant angles 200 and 202, wherein the slant angles orient the splitters to point in opposite directions. The beam splitters may also be viewed as being symmetrical about an axis 210 between said splitters. The beam path 220 as indicated by arrows 16, 222, 224, 226, and 228 extends through the beam splitters along a first longitudinal axis 64 and a second longitudinal axis 88. The beam path may also extend through the various devices as shown in FIG. 3.

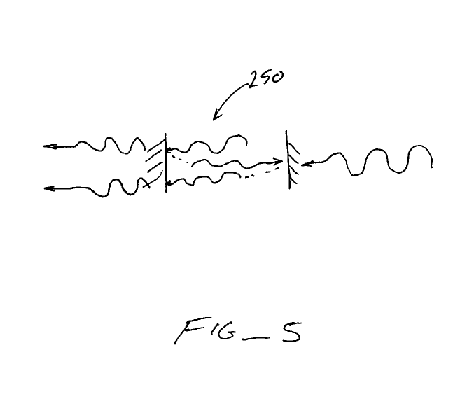

In some embodiments of the present invention, the wavelength selective member 104 may comprise of a variety of devices such as, but not limited to, fiber Bragg gratings, narrow-bandpass thin film filters, Lyot filters, and Fabry-Perot etalons, both solid and air-gap. As seen in FIG. 5, the etalon includes a gap or resonant cavity 250 between two highly reflective surfaces. This gap may be of a solid material or an air gap. The etalon can be designed to have its resonances spaced by the channel spacing between ITU grind channels. By changing the length of the cavity 250, these resonances can lock a tunable laser source 10 to any channel where the other types of wavelength selective elements are effective for only one channel or wavelength. The solid etalon is employed here as it can be miniaturized to the level needed for this application. Although not limited to the following, the Fabry-Perot etalon is a less costly solution but also has the capability of maintaining narrow line width for the laser source in a variety of environments.

When a solid etalon or other temperature sensitive device is used in wavelength locker 20, a thermistor 130 may also be included for monitoring the temperature inside the device. The readings from the thermistor 130 may be used to adjust for the signals coming from the optoelectronic device 110 receiving output from the wavelength selective optical member 104. For example, solid etalons lend themselves well to small applications but, as there is no truly athermal glass available today, they are sensitive to changes in temperature. This implies that solid etalons will change their resonance center wavelengths as the temperature changes. There are a couple of ways of dealing with this including an external calibration circuit that accounts for the changes in the etalon or a control circuit that maintains the temperature of the etalon environment. In one embodiment of the present invention, the etalon environment is controlled by incorporating both the thermoelectric cooler and control electronics into the package. A thermistor may be mounted on the wavelength locker platform and it may be a round disc. The thermistor may monitor the temperature of the etalon. The wavelength locker 20 may be mounted on a thermoelectric cooler to control the temperature and may be included as part of the wavelength locker packaging.

The mounting of isolator core and lenses with collimation and focusing capabilities on one platform would again minimize the need for active alignments in the butterfly package. The reason for achieving such optimization inside the source laser package would be mounting of different passive optics with pre-alignments on the internal wavelength locker platform. As seen in FIGS. 2 and 3, the wavelength selective optical member 104 may be positioned on various sides the of the housing as desired. In some embodiments, it should be understood that the wavelength selective optical member 104 may be positioned to receive light from the first beam splitter.

Additionally, the wavelength locker may include circuitry configured to alternate the polarity of wavelength selective optical member 104 transmission signal at alternating channels. The wavelength locker may be coupled to a laser feedback control servo system, the circuitry altering a polarity of the etalon transmission signal at alternating channels prior to a laser feedback control servo system receiving the etalon transmission signal. The positive and the negative slopes on the etalon response would be used. In this embodiment, this implies that the error signal would have different polarity for increasing and decreasing wavelengths dependent on which slope of the etalon response signal is used. In this embodiment, the use of both polarities makes it feasible to control laser's ITU grid wavelengths in 25 GHz channel spacing with a 50 GHz locker or etalon to be specific. This helps in part to keep the internal locker dimensions small enough to be implemented inside a butterfly package.

In one embodiment, the wavelength locker may combine features that make its useful as an internal wavelength locker combined with the etalon optical element, which accommodates the tunable nature of the laser chip. These features include the in-line design, the miniature size, the multi-channel nature of the etalon optics and the incorporation of a thermistor to control the environmental temperature.

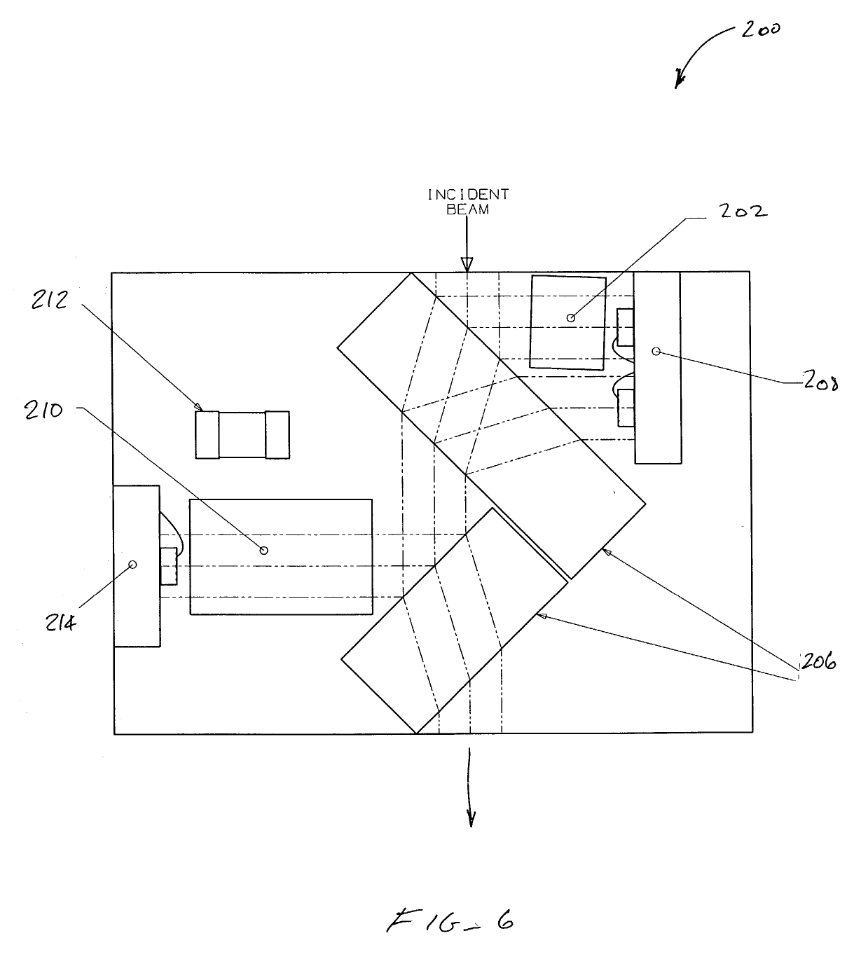

In another embodiment as seen in FIG. 6, the internal wavelength locker 200 may have a reference filter 202 for designating a reference ITU channel or wavelength. Although not limited to the following, the filter 202 may be a notch filter, a spike filter or a thin film narrow band pass WDM filter at the ITU channel. A signal from the first beam splitter 206 could be split to monitor reference channel as shown in FIG. 6. An optical coating may be provided on a second surface of the beam splitter or this may be based on total internal reflections. A reference diode 208 or an optical sensor may also be included. As seen in FIG. 6, part of the signal from the first beam splitter 206 passes through filter 202 to reach reference diode 208 while part of it does not pass through the filter to be in communication with reference diode 208. The wavelength locker 200 may further include an etalon 210, a thermistor 212, and an optoelectronic device 214 such as a signal diode. Again the present embodiment exhibits the zero displacement path. Given the reference filter, the laser source diode could be operated at a particular set of temperature and electrical current to have light pass through the reference filter. The set of conditions then become a standard calibration for the source laser operating at an ITU grid wavelength or other desired wavelength.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, the wavelength locker may be used with a variety of lasers transmitting at wavelengths on the ITU grid between 1528 nm and 1560 nm, at 1310 nm, at 1510 nm, or any other wavelength used in various optical systems. The wavelength locker may be used with widely tunable lasers or with less expensive lasers that may only be tunable over a smaller range. The system may be used with lasers that are adjust by controlling TEC. The present invention using an etalon can function at multiple wavelengths and a tunable laser source can be locked to different ITU GRID wavelengths using the compact internal wavelength locker. In addition, the current embodiment has been miniaturized in such a manner that it can be integrated directly into the source laser housing, has been designed so that the input and output are in-line for convenient integration, and simultaneously includes the temperature sensor to control the environment of the entire laser source. Expected variations or differences in the results are contemplated in accordance with the objects and practices of the present invention. It is intended, therefore, that the invention be defined by the scope of the claims which follow and that such claims be interpreted as broadly as is reasonable.

What is claimed is:

1. A laser system, comprising:
a laser source including a laser stabilizing control loop and a laser housing, the laser source producing an output beam;
a wavelength selective optical member positioned in the laser housing, the wavelength selective optical member adjusting wavelength and output power of the output beam in response to wavelength or power fluctuations of the laser source due to intrinsic aging of the laser source or due to extrinsic local environmental changes.

2. The system of claim 1 wherein said wavelength selective optical member comprises a solid etalon.

3. The system of claim 1 wherein said system further comprises a temperature control circuit and thermistor.

4. The system of claim 1 further comprising:
a platform supporting said wavelength selective member;
a beam path extending across said platform, said beam path supported by at least a lens, a first beam splitter oriented in a first direction, a second beam splitter oriented in a second opposite direction, and a focusing lens, wherein one of the beam splitters directs light to said wavelength selective member optically coupled to an optoelectronic device generating a signal used by said control loop for controlling at least one of the frequency or intensity of laser output.

5. The system of claim 4 further comprising a gradient index lens (GRIN) mounted to the platform.

6. The system of claim 4 further comprising:
a reference filter coupled to said first beam splitter is used to determine if light from said laser source is at a desired wavelength.

7. The system of claim 4 further comprising:
a reference filter, wherein said first beam splitter sends light through said reference filter to an optical sensor and first beam splitter sends light directly to said optical sensor without passing through the reference filter.

8. The system of claim 1 having a zero beam path offset configuration wherein laser output from the laser source passes through a first beam splitter and a second beam splitter, each with a partially reflective surface oriented symmetrically about an axis between the beam splitter, said axis substantially orthogonal to a longitudinal axis of said beam path.

9. The system of claim 8 wherein each partially reflective surface is oriented orthogonal to one another.

10. The system of claim 1 with a zero beam path offset configuration wherein laser output from the laser source passes through a first beam splitter having a partially reflective surface positioned at a first slant angle and a second beam splitter having a partially reflective surface at a second slant angle opposite said first slant angle.

11. The system of claim 1 sized to be packagable in an industry standard 14 pin butterfly housing.

12. The system of claim 1 further comprising a thermoelectric cooler/heater and two photodiodes within said housing.

13. The system of claim 1 wherein the wavelength selective optical member is selected from an etalon, narrow-bandpass filter, fiber Bragg grating, diffraction grating, volume hologram and Lyot filter.

14. The system of claim 13 wherein the etalon is configured to have a FSR at least equal to the ITU channel spacing.

15. The system of claim 1 wherein the wavelength selective optical member is a Fabry-Perot etalon.

16. The system of claim 1 wherein the laser source is coupled to a fiber.

17. The system of claim 1 wherein the laser source is selected from, a diode laser, edge-emitting Fabry-Perot laser and a VCSEL.

18. The system of claim 1 wherein the wavelength selective optical member has an in-line design.

19. The system of claim 1 wherein the wavelength selective optical member has a miniaturized size.

20. The system of claim 1 wherein the wavelength selective optical member includes multi-channel etalon optics.

21. The system of claim 1 wherein the wavelength selective optical member includes a thermistor.

22. The system of claim 1 wherein the wavelength selective optical member includes an external calibration circuit.

23. The system of claim 1 wherein the wavelength selective optical member includes an etalon and a control circuit configured to control a temperature of the etalon.

24. The device of claim 1 further comprising circuitry configured to alternate a polarity of an etalon transmission signal at alternating channels in said wavelength selective optical member.

25. A wavelength locker for controlling the wavelength and measuring the optical power of an output beam from a laser source, comprising:
a first beam splitter positioned in a beam path and receiving light produced by the laser source, the first beam splitter splitting a first beam into a second beam and a third beam;
a wavelength selective optical member positioned to receive the second beam from the first beam splitter and generate a fourth beam with an optical power that varies periodically with wavelength;
a first detector that generates a first signal in proportion to an optical power of the fourth beam; and
means for generating a second signal from which the optical power of the output beam can be derived; and wherein a wavelength of the output beam is adjusted in response to a comparison of the first and second signals and a predetermined reference signal level.

26. The device of claim 25 wherein the wavelength selective optical member is an etalon.

27. The device of claim 25 wherein the third beam is a beam transmitted through the wavelength selective optical member.

28. The device of claim 25 wherein a second detector is configured to receive a portion of an output beam of a laser and generate a second signal in proportion to the optical power of the output beam of the laser.

29. The device of claim 28 further comprising a base plate that mounts the etalon and the laser.

30. The device of claim 29 further comprising a thermal sensor mounted to the base plate.

31. The device of claim 26 wherein the etalon is made of a high index material.

32. The device of claim 31 wherein the high index material is selected from glass and a semiconductor material.

33. The device of claim 26 further comprising a photodiode coupled to the etalon.

34. The device of claim 26 wherein the etalon has a partial reflectivity coating.

35. The device of claim 26 wherein the etalon is a solid etalon.

36. The device of claim 26 wherein the etalon includes an air gap positioned between the front and back surfaces.

37. The device of claim 26 further comprising circuitry configured to alternate a polarity of an etalon transmission signal at alternating channels.

38. The device of claim 37 wherein the circuitry is coupled to a laser feedback control servo system, the circuitry altering a polarity of the etalon transmission signal at alternating channels prior to a laser feedback control servo system receiving the etalon transmission signal.

39. The device of claim 25 wherein said wavelength selective optical member comprises a solid etalon.

40. The device of claim 25 wherein said wavelength selective optical member further comprises a temperature control circuit and thermistor.

41. The device of claim 25 wherein said wavelength selective optical member is configured to support an in-line configuration for a beam path through said member sufficient so that input and output beams are substantially aligned along one longitudinal axis for facilitating optical coupling.

42. The device of claim 25 further comprising:
a platform supporting said wavelength selective member;
a beam path extending across said platform, said beam path supported by a lens, the first beam splitter oriented in a first direction, a second beam splitter oriented in a second opposite direction, and a focusing lens, wherein one of the beam splitters directs light to an optoelectronic device used to generate an error signal sufficient for controlling at least one of the frequency or intensity of laser output.

43. The device of claim 25 wherein said wavelength locker has a zero beam path deviation configuration wherein said beam path extends through the first beam splitter and a second beam splitter with partially reflective surfaces, each of said surfaces oriented in a manner sufficient so that the output beam entering the wavelength locker on one longitudinal axis exits said wavelength locker along the same longitudinal axis.

44. The device of claim 43 wherein each of said beam splitters directs light in an orthogonal direction away from the beam path.

45. The device of claim 25 with a zero beam path deviation configuration wherein a first beam splitter and a second beam splitter are oriented symmetrically about an axis between the beam splitters and orthogonal to a longitudinal axis of said beam path.

46. The device of claim 25 with a zero beam path deviation configuration wherein a first beam splitter has a partially reflective surface positioned at a first slant angle and a second beam splitter has a partially reflective surface at a second slant angle opposite said first slant angle.

47. The device of claim 25 sized to be packagable in an industry standard 14 pin butterfly housing.

48. The device of claim 25 further comprising a temperature sensor to control the environment of the entire laser source.

49. The devices of claim 25 further comprising:
a reference filter coupled to said first beam splitter is used to determine if light from said laser source is at a desired wavelength.

50. The devices of claim 25 further comprising:
a reference filter, wherein said first beam splitter sends light through said reference filter to an optical sensor and first beam splitter sends light directly to said optical sensor without passing through the reference filter.

51. A method for controlling wavelength and optical power, the method comprising:
providing a housing containing a laser and a wavelength locker;
sending a laser output from said laser to said wavelength locker;
directing said laser output through a first beam splitter in said housing, wherein said laser output entering the first beam splitter along a first longitudinal axis and exiting the first beam splitter along a second longitudinal axis;
directing said laser output through a second beam splitter in said housing, wherein said laser output exiting said second beam splitter is aligned to said first longitudinal axis; and
directing said laser output out of said housing.

52. The device of claim 51 further comprising using an etalon to determine wavelength error in the laser output, wherein output from the etalon is adjusted for by a measurements from a thermal sensor to account for shifts in temperature.

53. The device of claim 51 further comprising using an error signal having different polarity for increasing and decreasing wavelength error.

54. The device of claim 51 further comprising using a reference filter to provide a reference wavelength.
